(19) United States
(12) Patent Application Publication
(10) Pub. No.: US 2025/0234436 A1
(43) Pub. Date: Jul. 17, 2025

(54) LIGHTING APPARATUS

(71) Applicant: LEEDARSON LIGHTING CO.,LTD., Zhangzhou (CN)

(72) Inventors: Yinglong Chen, Zhangzhou (CN); Xiangqun Hong, Zhangzhou (CN); Hongkui Jiang, Zhangzhou (CN)

(21) Appl. No.: 19/026,244

(22) Filed: Jan. 16, 2025

(30) Foreign Application Priority Data
Jan. 16, 2024 (CN) 202420106419.4

(51) Int. Cl. H05B 45/24; H05B 45/59; H05B 47/11

(52) U.S. Cl. CPC H05B 45/24; H05B 45/59; H05B 47/11

(57) ABSTRACT

A lighting apparatus includes a rectifier bridge circuit, a light source, a LED controller, a dimmer detector circuit and a bleeder circuit. The rectifier bridge circuit converts an AC power to a DC power. The LED controller for generates a plurality of driving currents based on the DC power to respectively control plurality of LED modules of different types. The dimmer detector circuit detects whether a dimmer is coupled to the lighting apparatus. The bleeder circuit is coupled to the dimmer detector circuit. The bleeder circuit is configured to be turned on when the dimmer detector circuit detects that the dimmer is coupled to the lighting apparatus for fixing a signal distortion for power input to the LED controller. The signal distortion is caused by the dimmer.

### FIELD

The present invention is related to a lighting apparatus, and more particularly related to a lighting apparatus with convenient configuration.

### BACKGROUND

A dimmer in a lighting device is an essential tool that allows users to control the intensity of light, creating the desired ambiance in a room or environment. By adjusting the voltage or current supplied to the light source, a dimmer modifies the brightness level, enabling settings that range from full illumination to a soft, subdued glow. This ability to control brightness is particularly useful in residential spaces, offices, and entertainment venues, as it allows users to tailor the lighting to their specific needs, whether for reading, relaxation, or creating a dramatic visual effect.

Modern dimmers can alter various parameters beyond just brightness. For example, in advanced LED lighting systems, dimmers can also adjust color temperature, shifting from warm tones to cooler, daylight-like tones. Some dimmers integrated with smart lighting systems can control color combinations, enabling users to create vibrant or subtle light effects for aesthetic or functional purposes. This versatility makes dimmers a crucial component in achieving energy efficiency, as lower light levels consume less power, extending the lifespan of the light source and reducing electricity costs.

Traditionally, dimmers have been installed on walls as part of a room's electrical system. Wall-mounted dimmers are connected to the lighting circuit and typically feature a rotating knob, sliding switch, or touch-sensitive interface. These physical controls allow easy manual adjustment of light intensity, often with a tactile or visual indicator to show the current brightness level. Wall dimmers are frequently positioned near entry points of a room, offering convenient access for controlling lighting as one enters or exits.

Wall-mounted dimmers are widely used in homes and commercial spaces due to their simplicity and effectiveness. They are often installed alongside standard light switches and are compatible with a variety of light sources, including incandescent, halogen, and some LEDs. Users can dim lights to reduce glare during movie nights, lower brightness for a cozy dinner, or increase illumination for cleaning or detailed work. The straightforward design of these dimmers makes them a popular choice for those seeking basic lighting control without requiring advanced features.

Despite their traditional use, wall dimmers have evolved significantly to include features like remote control, programmable settings, and smart home integration. Many modern dimmers can now be operated through mobile apps or voice commands, providing greater convenience and flexibility. This evolution allows users to adjust lighting parameters remotely or automate changes based on schedules or sensors. As lighting technology continues to advance, the role of dimmers remains pivotal in enhancing the usability, efficiency, and aesthetic appeal of lighting systems.

LED technology has revolutionized light device design, becoming the standard for modern illumination due to its unparalleled efficiency and versatility. Unlike traditional light sources such as incandescent or fluorescent bulbs, LEDs (light-emitting diodes) are highly energy-efficient, converting a significant portion of electrical energy into visible light with minimal heat loss. This efficiency not only reduces energy consumption but also translates into lower electricity bills and a smaller environmental footprint, making LEDs an eco-friendly choice for both residential and commercial lighting.

Another advantage of LED technology is its remarkable durability and longevity. LEDs can operate for tens of thousands of hours, far outlasting traditional light bulbs. This extended lifespan reduces the frequency of replacements, which is particularly valuable in hard-to-reach installations or applications requiring constant, reliable lighting. Additionally, the robust construction of LEDs, often encapsulated in solid-state materials, makes them resistant to shock, vibrations, and extreme temperatures, enhancing their reliability in diverse environments.

LEDs also offer unparalleled design flexibility, enabling the creation of innovative lighting devices tailored to specific needs. Their small size and directional light output make them suitable for compact, intricate designs, such as decorative fixtures or task lighting. Furthermore, advancements in LED technology allow for precise control over color, brightness, and beam angle, which designers can leverage to create dynamic lighting effects or meet stringent performance criteria. This versatility is why LEDs are commonly used in applications ranging from architectural lighting to automotive headlights and beyond.

A significant benefit of LEDs is their compatibility with smart lighting systems, which are increasingly in demand for home automation and energy management. LEDs can be seamlessly integrated with dimmers, sensors, and controllers, offering users the ability to adjust brightness, color temperature, or even light patterns through mobile apps or voice commands. This integration not only enhances convenience but also provides data-driven insights into energy usage, allowing for further optimization of lighting systems to save costs and reduce waste.

The environmental benefits of LED technology extend beyond energy efficiency. LEDs are free from toxic elements like mercury, commonly found in fluorescent lights, making them safer for disposal and recycling. Additionally, their lower energy requirements reduce the strain on power grids and decrease greenhouse gas emissions associated with electricity production. As governments and industries worldwide adopt stricter sustainability goals, the widespread implementation of LED lighting plays a crucial role in achieving these targets while maintaining high-quality illumination.

Maintaining compatibility with traditional dimmer designs while incorporating the new technology of LEDs is critical for ensuring a seamless transition to modern lighting systems. Traditional dimmers, commonly found in homes and commercial spaces, were originally designed for incandescent bulbs and operate by cutting the AC waveform to adjust brightness. LED technology, with its distinct electrical properties, often requires specialized circuits or drivers to work with these dimmers effectively. By designing LED lighting systems that remain compatible with existing dimmers, manufacturers can simplify the adoption process for consumers, eliminating the need for costly rewiring or replacement of dimmer infrastructure.

This compatibility is particularly beneficial for retaining the user-friendly features and familiar interfaces of traditional dimmers. Many consumers and professionals rely on the tactile control and simplicity of existing dimmer switches, which are widely installed and understood. By ensuring that LED systems integrate seamlessly with these dimmers, manufacturers can offer a consistent user experience while delivering the energy efficiency, longevity, and advanced features of LED technology. Compatibility also opens up opportunities for mixed-use environments where both traditional and LED lighting may coexist, providing flexibility in upgrading lighting systems incrementally rather than requiring an all-at-once overhaul.

Beyond practicality, fostering compatibility with traditional dimmers paves the way for inventive solutions that bridge old and new technologies. Developing advanced LED controllers that can interpret and respond to the signals from legacy dimmers introduces novel methods of enhancing performance and user satisfaction. For instance, such innovations could include adaptive drivers that dynamically optimize brightness and color consistency in response to dimmer settings or hybrid systems that transition effortlessly between traditional dimmer control and smart lighting functionality. These advancements not only make LED systems more versatile but also ensure that new technology respects and builds upon existing infrastructure, accelerating adoption while opening the door to groundbreaking inventions.

### SUMMARY

In some embodiments, a lighting apparatus includes a rectifier bridge circuit, a light source, a LED controller, a dimmer detector circuit and a bleeder circuit.

The rectifier bridge circuit converts an AC power to a DC power.

The light source includes a plurality of LED modules of different types.

The LED controller for generates a plurality of driving currents based on the DC power to respectively control the plurality of LED modules of different types.

The dimmer detector circuit detects whether a dimmer is coupled to the lighting apparatus.

The bleeder circuit is coupled to the dimmer detector circuit.

The bleeder circuit is configured to be turned on when the dimmer detector circuit detects that the dimmer is coupled to the lighting apparatus for fixing a signal distortion for power input to the LED controller.

The signal distortion is caused by the dimmer.

In some embodiments, the multiple types of LED modules includes a red LED module, a blue LED module, a green LED module, a cool white LED module and a warm white LED module.

In some embodiments, the signal distortion of the AC power is chopped by the dimmer.

In some embodiments, the dimmer detector circuit includes: a chip including a plurality of pins.

The plurality of pins includes a TRIAC pin, a HV pin, a CS1 pin, a CS2 pin, a VIN pin, a DRAIN pin, a RTH pin, a VD pin, and a GND pin. a first resistor including a first terminal and a second terminal.

The first terminal of the first resistor is coupled to the TRIAC pin of the chip.

The second terminal of the first resistor is coupled to the rectifier bridge circuit, the bleeder circuit, and a first terminal of a sixth resistor. a second resistor including a first terminal and a second terminal.

The first terminal of the second resistor is coupled to the CS1 pin of the chip. a third resistor including a first terminal and a second terminal.

The first terminal of the third resistor is coupled to the second terminal of the second resistor and the CS2 pin of the chip. a fourth resistor including a first terminal and a second terminal.

The first terminal of the fourth resistor is coupled to the second terminal of the second resistor and the CS2 pin of the chip.

The second terminal of the fourth resistor is coupled to the second terminal of the third resistor and the GND pin of the chip.

The VIN pin of the chip is coupled to a second terminal of the sixth resistor. a seventh resistor including a first terminal and a second terminal.

The first terminal of the seventh resistor is coupled to the DRAIN pin of the chip and the bleeder circuit.

The second terminal of the seventh resistor is coupled to the VD pin of the chip.

In some embodiments, the bleeder circuit includes: a diode including an anode terminal and a cathode terminal.

The anode terminal of the diode is coupled to the second terminal of the first resistor, the second terminal of the sixth resistor, and the rectifier bridge circuit. a resistor including a first terminal and a second terminal.

The first terminal of the resistor is coupled to the cathode terminal of the diode. a capacitor including a positive terminal and a negative terminal.

The negative terminal of the capacitor is coupled to the cathode terminal of the diode and the first terminal of the resistor.

The positive terminal of the capacitor is coupled to the second terminal of the resistor, the second terminal of the seventh resistor, and the LED controller circuit.

In some embodiments, the LED controller includes: a resistor including a first terminal and a second terminal. a first capacitor including a first terminal and a second terminal. a second capacitor including a first terminal and a second terminal. a first LED string including a positive terminal and a negative terminal.

The first LED string includes a plurality of blue LEDs. a second LED string including a positive terminal and a negative terminal.

The second LED string includes a plurality of red LEDs. a third LED string including a positive terminal and a negative terminal.

The third LED string includes a plurality of green LEDs. a fourth LED string including a positive terminal and a negative terminal.

The fourth LED string includes a plurality of white LEDs. a fifth LED string including a positive terminal and a negative terminal.

The fifth LED string includes a plurality of cyan LEDs.

The first terminal of the resistor is coupled to the cathode terminal of the diode, the negative terminal of the capacitor, the second terminal of the resistor of the bleeder circuit, the positive terminal of the first LED string, the positive terminal of the second LED string, the positive terminal of the third LED string, the positive terminal of the fourth LED string, and the positive terminal of the fifth LED string.

The second terminal of the resistor is coupled to the control chip.

The first terminal of the first capacitor is coupled to the control chip.

The first terminal of the second capacitor is coupled to the positive terminal of the capacitor of the bleeder circuit, the second terminal of the resistor of the bleeder circuit, the second terminal of the seventh resistor, and the control chip.

The second terminal of the second capacitor is coupled to the control chip.

The negative terminal of the first LED string is coupled to the control chip.

The negative terminal of the second LED string is coupled to the control chip.

The negative terminal of the third LED string is coupled to the control chip.

The negative terminal of the fourth LED string is coupled to the control chip.

The negative terminal of the fifth LED string is coupled to the control chip.

The control chip includes: a DUT1 pin, a VIN pin, a DATA pin, a CLK pin, a DUT2 pin, a DUT3 pin, a DUT4 pin, and a DUT5 pin.

The DUT1 pin is coupled to the negative terminal of the first LED string.

The VIN pin is coupled to the second terminal of the resistor.

The DATA pin is coupled to the first terminal of the first capacitor.

The CLK pin is coupled to the first terminal of the second capacitor.

The DUT2 pin is coupled to the negative terminal of the second LED string.

The DUT3 pin is coupled to the negative terminal of the third LED string.

The DUT4 pin is coupled to the negative terminal of the fourth LED string.

The DUT5 pin is coupled to the negative terminal of the fifth LED string.

In some embodiments, the LED controller circuit is configured to: detect a voltage ripple pattern of the DC power during a plurality of dimming cycles. determine a dimming curve based on the voltage ripple pattern. adjust brightness levels of the plurality of LED modules of different types according to different scaling factors derived from the dimming curve.

Each type of the plurality of LED modules has a unique scaling factor to maintain a desired color mixing ratio across different dimming levels.

In FIG. 5, the bleeder circuit 701 includes: a dynamic impedance adjustment circuit 702 configured to modulate an impedance value of the bleeder circuit based on a detected phase angle of the dimmer, a thermal protection circuit 703 configured to temporarily disable the bleeder circuit when a temperature of the bleeder circuit exceeds a threshold value.

The thermal protection circuit is further configured to re-enable the bleeder circuit in a pulse width modulated manner to maintain dimmer compatibility while reducing heat generation.

In some embodiments, the lighting apparatus may also include a dimming pattern learning circuit 705 configured to store a plurality of historical dimming patterns.

The dimming pattern learning circuit is configured to identify a type of the dimmer based on comparing a current dimming pattern with the plurality of historical dimming patterns.

The LED controller circuit is configured to adjust operation parameters of the bleeder circuit based on the identified type of the dimmer to optimize power efficiency while maintaining dimmer compatibility.

In some embodiments, the lighting apparatus may also include a dimmer health monitoring circuit configured to: detect abnormal behavior patterns of the dimmer. predict potential dimmer failure based on the detected abnormal behavior patterns. adjust operating parameters of the bleeder circuit to extend operational lifetime of the dimmer while maintaining normal operation of the lighting apparatus.

In some embodiments, the LED controller is further configured to dynamically adjust the plurality of driving currents based on a detected color temperature setting, enabling the light source to produce a tunable white light by combining the outputs of the plurality of LED modules.

In some embodiments, the dimmer detector circuit further includes a signal analysis module capable of distinguishing between leading-edge and trailing-edge dimmers.

The LED controller adjusts the plurality of driving currents based on the dimmer type detected to ensure compatibility and optimal performance.

In some embodiments, the bleeder circuit further includes an adaptive feedback mechanism configured to minimize power loss by adjusting its operation based on the real-time impedance of the dimmer coupled to the lighting apparatus.

In some embodiments, the LED controller is configured to independently modulate the intensity of each LED module based on ambient light detected by an integrated light sensor, providing automatic brightness adjustment for energy efficiency.

In some embodiments, the LED controller includes a flicker mitigation module that adjusts the driving currents to maintain a constant and flicker-free light output, even under varying input power conditions caused by the dimmer.

In some embodiments, the LED controller further includes an emergency mode circuit that detects power interruptions and switches the lighting apparatus to a low-power mode using stored energy in a backup capacitor to illuminate a subset of the LED modules.

In some embodiments, the lighting apparatus may also include a manual switch operably connected to the dimmer detector circuit.

The manual switch allows a user to manually indicate whether a dimmer is connected, and the LED controller adjusts the plurality of driving currents accordingly to optimize compatibility and performance.

In some embodiments, the lighting apparatus may also include a manual switch for user input to override the dimmer detector circuit.

The manual switch enables a predefined non-dimmer mode to bypass dimmer-related adjustments by the LED controller, ensuring stable operation in scenarios where a dimmer is not used.

### BRIEF DESCRIPTION OF DRAWINGS

FIG. 1 illustrates an embodiment of a lighting apparatus embodiment.

FIG. 2 illustrates an adjusted power that is not distorted by the dimmer.

FIG. 3 illustrates a distorted signal that is chopped by the dimmer.

FIG. 4 illustrates another lighting apparatus embodiment.

FIG. 5 shows another embodiment components.

### DETAILED DESCRIPTION

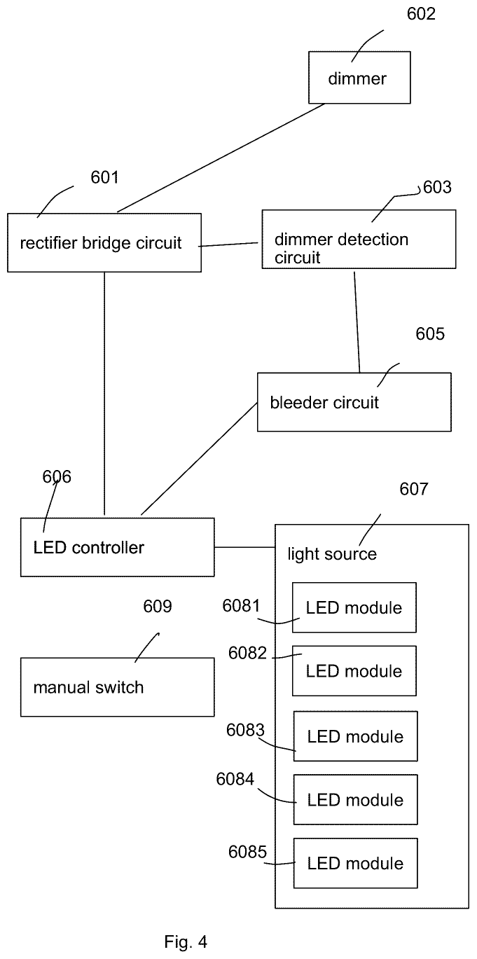

In FIG. 4, a lighting apparatus includes a rectifier bridge circuit 601, a light source 607, a LED controller 606, a dimmer detector circuit 603 and a bleeder circuit 605.

The rectifier bridge circuit 601 converts an AC power to a DC power.

The light source 607 includes a plurality of LED modules of different types. For example, the LED modules 6081, 6082, 6083, 6084, 6085 are red LED module, green LED module, blue LED module, cool white LED module and warm white LED module, where the last two LED modules are white LED modules for emitting white lights with different distribution on color temperatures.

The LED controller 606 generates a plurality of driving currents based on the DC power to respectively control the plurality of LED modules of different types.

The dimmer detector circuit detects whether a dimmer is coupled to the lighting apparatus.

The bleeder circuit is coupled to the dimmer detector circuit.

The bleeder circuit is configured to be turned on when the dimmer detector circuit detects that the dimmer is coupled to the lighting apparatus for fixing a signal distortion for power input to the LED controller.

The signal distortion is caused by the dimmer.

In some embodiments, the multiple types of LED modules include a red LED module, a blue LED module, a green LED module, a cool white LED module and a warm white LED module.

In some embodiments, the signal distortion of the AC power is chopped by the dimmer.

In some embodiments, the dimmer detector circuit includes: a chip including a plurality of pins.

The plurality of pins includes a TRIAC pin, a HV pin, a CS1 pin, a CS2 pin, a VIN pin, a DRAIN pin, a RTH pin, a VD pin, and a GND pin. a first resistor including a first terminal and a second terminal.

The first terminal of the first resistor is coupled to the TRIAC pin of the chip.

The second terminal of the first resistor is coupled to the rectifier bridge circuit, the bleeder circuit, and a first terminal of a sixth resistor. a second resistor including a first terminal and a second terminal.

The first terminal of the second resistor is coupled to the CS1 pin of the chip. a third resistor including a first terminal and a second terminal.

The first terminal of the third resistor is coupled to the second terminal of the second resistor and the CS2 pin of the chip. a fourth resistor including a first terminal and a second terminal.

The first terminal of the fourth resistor is coupled to the second terminal of the second resistor and the CS2 pin of the chip.

The second terminal of the fourth resistor is coupled to the second terminal of the third resistor and the GND pin of the chip.

The VIN pin of the chip is coupled to a second terminal of the sixth resistor. a seventh resistor including a first terminal and a second terminal.

The first terminal of the seventh resistor is coupled to the DRAIN pin of the chip and the bleeder circuit.

The second terminal of the seventh resistor is coupled to the VD pin of the chip.

In some embodiments, the bleeder circuit includes: a diode including an anode terminal and a cathode terminal.

The anode terminal of the diode is coupled to the second terminal of the first resistor, the second terminal of the sixth resistor, and the rectifier bridge circuit. a resistor including a first terminal and a second terminal.

The first terminal of the resistor is coupled to the cathode terminal of the diode. a capacitor including a positive terminal and a negative terminal.

The negative terminal of the capacitor is coupled to the cathode terminal of the diode and the first terminal of the resistor.

The positive terminal of the capacitor is coupled to the second terminal of the resistor, the second terminal of the seventh resistor, and the LED controller circuit.

In some embodiments, the LED controller includes: a resistor including a first terminal and a second terminal. a first capacitor including a first terminal and a second terminal. a second capacitor including a first terminal and a second terminal. a first LED string including a positive terminal and a negative terminal.

The first LED string includes a plurality of blue LEDs. a second LED string including a positive terminal and a negative terminal.

The second LED string includes a plurality of red LEDs. a third LED string including a positive terminal and a negative terminal.

The third LED string includes a plurality of green LEDs. a fourth LED string including a positive terminal and a negative terminal.

The fourth LED string includes a plurality of white LEDs. a fifth LED string including a positive terminal and a negative terminal.

The fifth LED string includes a plurality of cyan LEDs.

The first terminal of the resistor is coupled to the cathode terminal of the diode, the negative terminal of the capacitor, the second terminal of the resistor of the bleeder circuit, the positive terminal of the first LED string, the positive terminal of the second LED string, the positive terminal of the third LED string, the positive terminal of the fourth LED string, and the positive terminal of the fifth LED string.

The second terminal of the resistor is coupled to the control chip.

The first terminal of the first capacitor is coupled to the control chip.

The first terminal of the second capacitor is coupled to the positive terminal of the capacitor of the bleeder circuit, the second terminal of the resistor of the bleeder circuit, the second terminal of the seventh resistor, and the control chip.

The second terminal of the second capacitor is coupled to the control chip.

The negative terminal of the first LED string is coupled to the control chip.

The negative terminal of the second LED string is coupled to the control chip.

The negative terminal of the third LED string is coupled to the control chip.

The negative terminal of the fourth LED string is coupled to the control chip.

The negative terminal of the fifth LED string is coupled to the control chip.

The control chip includes: a DUT1 pin, a VIN pin, a DATA pin, a CLK pin, a DUT2 pin, a DUT3 pin, a DUT4 pin, and a DUT5 pin.

The DUT1 pin is coupled to the negative terminal of the first LED string.

The VIN pin is coupled to the second terminal of the resistor.

The DATA pin is coupled to the first terminal of the first capacitor.

The CLK pin is coupled to the first terminal of the second capacitor.

The DUT2 pin is coupled to the negative terminal of the second LED string.

The DUT3 pin is coupled to the negative terminal of the third LED string.

The DUT4 pin is coupled to the negative terminal of the fourth LED string.

The DUT5 pin is coupled to the negative terminal of the fifth LED string.

In some embodiments, the LED controller circuit is configured to: detect a voltage ripple pattern of the DC power during a plurality of dimming cycles. determine a dimming curve based on the voltage ripple pattern. adjust brightness levels of the plurality of LED modules of different types according to different scaling factors derived from the dimming curve.

Each type of the plurality of LED modules has a unique scaling factor to maintain a desired color mixing ratio across different dimming levels.

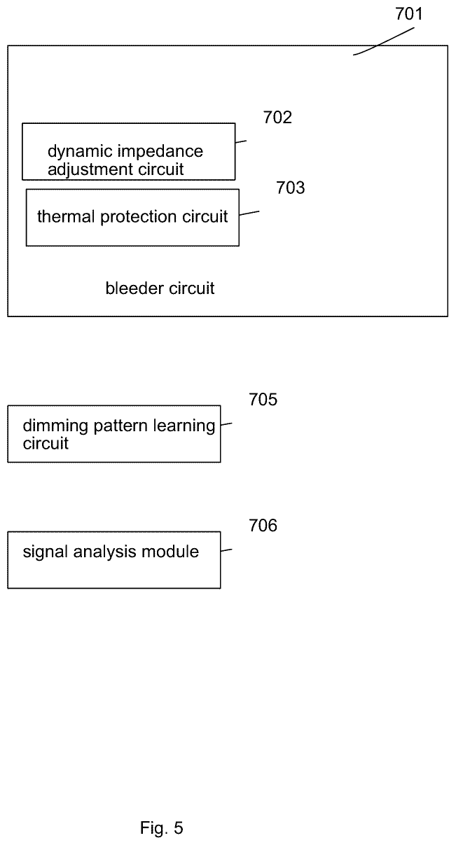

In FIG. 5, the bleeder circuit 701 includes: a dynamic impedance adjustment circuit 702 configured to modulate an impedance value of the bleeder circuit based on a detected phase angle of the dimmer, a thermal protection circuit 703 configured to temporarily disable the bleeder circuit when a temperature of the bleeder circuit exceeds a threshold value.

The thermal protection circuit is further configured to re-enable the bleeder circuit in a pulse width modulated manner to maintain dimmer compatibility while reducing heat generation.

In some embodiments, the lighting apparatus may also include a dimming pattern learning circuit configured to store a plurality of historical dimming patterns.

In FIG. 5, the dimming pattern learning circuit 705 signal is configured to identify a type of the dimmer based on comparing a current dimming pattern with the plurality of historical dimming patterns.

The LED controller circuit is configured to adjust operation parameters of the bleeder circuit based on the identified type of the dimmer to optimize power efficiency while maintaining dimmer compatibility.

In some embodiments, the LED controller circuit includes:

In some embodiments, the lighting apparatus may also include a dimmer health monitoring circuit configured to: detect abnormal behavior patterns of the dimmer. predict potential dimmer failure based on the detected abnormal behavior patterns. adjust operating parameters of the bleeder circuit to extend operational lifetime of the dimmer while maintaining normal operation of the lighting apparatus.

In some embodiments, the LED controller is further configured to dynamically adjust the plurality of driving currents based on a detected color temperature setting, enabling the light source to produce a tunable white light by combining the outputs of the plurality of LED modules.

In FIG. 5, the dimmer detector circuit further includes a signal analysis module 706 capable of distinguishing between leading-edge and trailing-edge dimmers.

The LED controller adjusts the plurality of driving currents based on the dimmer type detected to ensure compatibility and optimal performance.

In some embodiments, the bleeder circuit further includes an adaptive feedback mechanism configured to minimize power loss by adjusting its operation based on the real-time impedance of the dimmer coupled to the lighting apparatus.

In some embodiments, the LED controller is configured to independently modulate the intensity of each LED module based on ambient light detected by an integrated light sensor, providing automatic brightness adjustment for energy efficiency.

In some embodiments, the LED controller includes a flicker mitigation module that adjusts the driving currents to maintain a constant and flicker-free light output, even under varying input power conditions caused by the dimmer.

In some embodiments, the LED controller further includes an emergency mode circuit that detects power interruptions and switches the lighting apparatus to a low-power mode using stored energy in a backup capacitor to illuminate a subset of the LED modules.

In some embodiments, the lighting apparatus may also include a manual switch operably connected to the dimmer detector circuit.

The manual switch allows a user to manually indicate whether a dimmer is connected, and the LED controller adjusts the plurality of driving currents accordingly to optimize compatibility and performance.

In some embodiments, the lighting apparatus may also include a manual switch 609 for user input to override the dimmer detector circuit.

The manual switch 609 enables a predefined non-dimmer mode to bypass dimmer-related adjustments by the LED controller, ensuring stable operation in scenarios where a dimmer is not used.

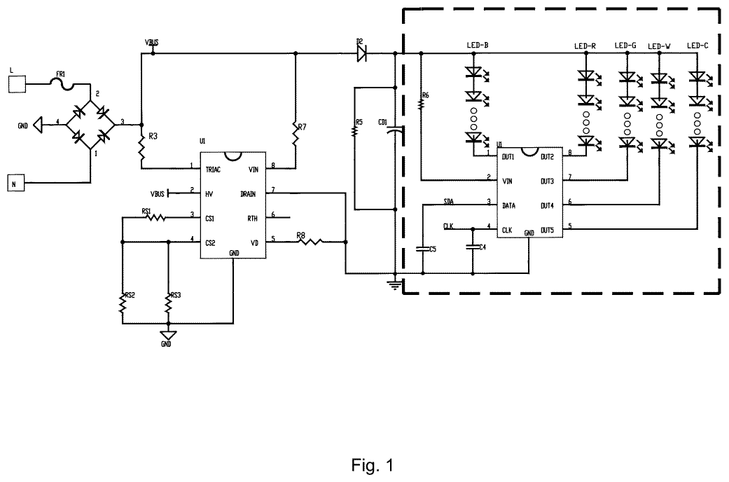

FIG. 1 illustrates an embodiment of a lighting apparatus embodiment.

FIG. 1 is a circuit structure diagram of a smart lamp compatible with a dimmer according to an embodiment. As shown in FIG. 1, the circuit includes: a rectifier bridge circuit, a dimmer-compatible circuit, an RGBCW five-channel LED control circuit, and a discharge circuit. The rectifier bridge circuit is simultaneously connected to the dimmer-compatible circuit, the RGBCW five-channel LED control circuit, and the discharge circuit. The output terminal of the dimmer-compatible circuit is simultaneously connected to the RGBCW five-channel LED control circuit and the discharge circuit. The RGBCW five-channel LED control circuit is connected to the discharge circuit. The dimmer-compatible circuit is configured to detect whether a dimmer exists in the circuit to control the opening and closing of the discharge circuit.

By connecting a Triac dimming IC at the front end of the communication smart product circuit, PWM or I2C protocol-controlled smart products can be compatible with dimmers without affecting any usage.

Specifically, the dimmer-compatible circuit includes: chip U1b, resistor R3b, resistor RS1b, resistor RS2b, resistor RS3b, resistor R7b, and resistor R8b. Chip U1b includes: TRIAC, HV, CS1, CS2, VIN, DRAIN, RTH, VD, and GND pins. The TRIAC pin connects to one end of resistor R3b. The other end of resistor R3b simultaneously connects to the rectifier bridge circuit, one end of resistor R7b, and the discharge circuit. The CS1 pin connects to one end of resistor RS1b. The other end of resistor RS1b simultaneously connects to one end of resistor RS2b, one end of resistor RS3b, and the CS2 pin. The other end of resistor RS3b simultaneously connects to the other end of resistor RS2b and the GND pin. The VIN pin connects to the other end of resistor R7b. The DRAIN pin simultaneously connects to one end of resistor R8b and the discharge circuit. The VD pin connects to the other end of resistor R8b.

Specifically, the discharge circuit includes: diode D2b, resistor R5b, and capacitor CD1b. The positive pole of diode D2b simultaneously connects to the end of resistor R3b away from chip U1b, the end of resistor R7b away from chip U1b, and the rectifier bridge circuit. The negative pole of diode D2b simultaneously connects to one end of resistor R5b and the negative pole of capacitor CD1b. The positive pole of capacitor CD1b simultaneously connects to the other end of resistor R5b, the end of resistor R8b away from chip U1b, and the RGBCW five-channel LED control circuit.

Specifically, the RGBCW five-channel LED control circuit includes: resistor R6b, chip U2b, capacitor C4b, capacitor C5b, LED-B diode string, LED-R diode string, LED-G diode string, LED-W diode string, and LED-C diode string. One end of resistor R6b simultaneously connects to the negative pole of diode D2b, the negative pole of capacitor CD1b, the end of resistor R5b away from chip U1b, the positive poles of LED-B, LED-R, LED-G, LED-W, and LED-C diode strings. The other end of resistor R6b connects to chip U2b. One end of capacitor C5b connects to chip U2b. The other end of resistor R5b simultaneously connects to the positive pole of capacitor CD1b, the end of resistor R5b near chip U1b, one end of capacitor C4b, chip U2b, and one end of resistor R8b. The other end of capacitor C4b connects to chip U2b. The negative poles of LED-B, LED-R, LED-G, LED-W, and LED-C diode strings connect to chip U2b.

Specifically, chip U2b includes: DUT1, VIN, DATA, CLK, DUT2, DUT3, DUT4, and DUT5 pins. The DUT1 pin connects to the negative pole of the LED-B diode string. The VIN pin connects to the end of resistor R6b away from diode D2b. The DATA pin connects to the end of capacitor C5b near chip U2b. The CLK pin connects to the end of capacitor C4b near chip U2b. DUT2 connects to the negative pole of the LED-R diode string. The DUT3 pin connects to the negative pole of the LED-G diode string. The DUT4 pin connects to the negative pole of the LED-W diode string. The DUT5 pin connects to the negative pole of the LED-C diode string.

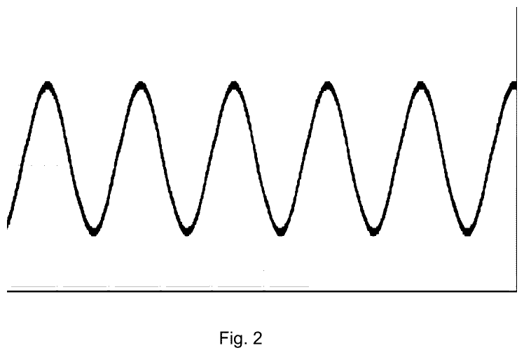

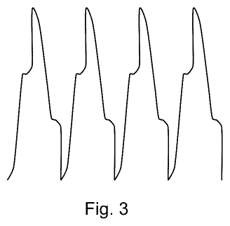

Since the RGBCW five-channel LED control circuit is a linear circuit, its working state varies with input voltage changes. When there is a dimmer at the input front end of the RGBCW five-channel LED control circuit, as shown in FIG. 3, the input voltage waveform will be chopped. Compared with the voltage waveform without a dimmer in FIG. 2, the presence of a dimmer leads to insufficient working voltage supplied to chip U2b, making it unable to control the LED output circuit, causing flickering and very small output power, making the light dim.

Due to the presence of the dimmer-compatible circuit, through the Triac pin in chip U1b detecting whether there is a dimmer, when the chip detects a dimmer, it will automatically open the discharge circuit to improve SCR dimmer compatibility. When the chip detects no dimmer, it will close the discharge current to reduce loss and improve system efficiency.

FIG. 2 illustrates an adjusted power that is not distorted by the dimmer. In FIG. 2, an alternative AC current is kept by using bleeder circuit.

FIG. 3 illustrates a distorted signal that is chopped by the dimmer. In this example, the AC current is chopped by the dimmer which may cause insufficient power to the LED controller.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a rectifier bridge circuit for converting an AC power to a DC power;
a light source comprising a plurality of LED modules of different types;
a LED controller for generating a plurality of driving currents based on the DC power to respectively control the plurality of LED modules of different types;
a dimmer detector circuit for detecting whether a dimmer is coupled to the lighting apparatus; and
a bleeder circuit coupled to the dimmer detector circuit, wherein the bleeder circuit is configured to be turned on when the dimmer detector circuit detects that the dimmer is coupled to the lighting apparatus for fixing a signal distortion for power input to the LED controller, wherein the signal distortion is caused by the dimmer.

2. The lighting apparatus of claim 1, wherein the multiple types of LED modules include a red LED module, a blue LED module, a green LED module, a cool white LED module and a warm white LED module.

3. The lighting apparatus of claim 1, wherein the signal distortion of the AC power being chopped by the dimmer.

4. The lighting apparatus of claim 1, wherein the dimmer detector circuit comprises: a chip comprising a plurality of pins, wherein the plurality of pins comprises a TRIAC pin, a HV pin, a CS1 pin, a CS2 pin, a VIN pin, a DRAIN pin, a RTH pin, a VD pin, and a GND pin; a first resistor comprising a first terminal and a second terminal, wherein the first terminal of the first resistor is coupled to the TRIAC pin of the chip, wherein the second terminal of the first resistor is coupled to the rectifier bridge circuit, the bleeder circuit, and a first terminal of a sixth resistor; a second resistor comprising a first terminal and a second terminal, wherein the first terminal of the second resistor is coupled to the CS1 pin of the chip; a third resistor comprising a first terminal and a second terminal, wherein the first terminal of the third resistor is coupled to the second terminal of the second resistor and the CS2 pin of the chip; a fourth resistor comprising a first terminal and a second terminal, wherein the first terminal of the fourth resistor is coupled to the second terminal of the second resistor and the CS2 pin of the chip, wherein the second terminal of the fourth resistor is coupled to the second terminal of the third resistor and the GND pin of the chip, wherein the VIN pin of the chip is coupled to a second terminal of the sixth resistor; a seventh resistor comprising a first terminal and a second terminal, wherein the first terminal of the seventh resistor is coupled to the DRAIN pin of the chip and the bleeder circuit, wherein the second terminal of the seventh resistor is coupled to the VD pin of the chip.

5. The lighting apparatus of claim 4, wherein the bleeder circuit comprises: a diode comprising an anode terminal and a cathode terminal, wherein the anode terminal of the diode is coupled to the second terminal of the first resistor, the second terminal of the sixth resistor, and the rectifier bridge circuit; a resistor comprising a first terminal and a second terminal, wherein the first terminal of the resistor is coupled to the cathode terminal of the diode; a capacitor comprising a positive terminal and a negative terminal, wherein the negative terminal of the capacitor is coupled to the cathode terminal of the diode and the first terminal of the resistor; wherein the positive terminal of the capacitor is coupled to the second terminal of the resistor, the second terminal of the seventh resistor, and the LED controller circuit.

6. The lighting apparatus of claim 5, wherein the LED controller comprises: a resistor comprising a first terminal and a second terminal; a first capacitor comprising a first terminal and a second terminal; a second capacitor comprising a first terminal and a second terminal; a first LED string comprising a positive terminal and a negative terminal, wherein the first LED string comprises a plurality of blue LEDs; a second LED string comprising a positive terminal and a negative terminal, wherein the second LED string comprises a plurality of red LEDs; a third LED string comprising a positive terminal and a negative terminal, wherein the third LED string comprises a plurality of green LEDs; a fourth LED string comprising a positive terminal and a negative terminal, wherein the fourth LED string comprises a plurality of white LEDs; a fifth LED string comprising a positive terminal and a negative terminal, wherein the fifth LED string comprises a plurality of cyan LEDs; wherein the first terminal of the resistor is coupled to the cathode terminal of the diode, the negative terminal of the capacitor, the second terminal of the resistor of the bleeder circuit, the positive terminal of the first LED string, the positive terminal of the second LED string, the positive terminal of the third LED string, the positive terminal of the fourth LED string, and the positive terminal of the fifth LED string; wherein the second terminal of the resistor is coupled to the control chip; wherein the first terminal of the first capacitor is coupled to the control chip; wherein the first terminal of the second capacitor is coupled to the positive terminal of the capacitor of the bleeder circuit, the second terminal of the resistor of the bleeder circuit, the second terminal of the seventh resistor, and the control chip; wherein the second terminal of the second capacitor is coupled to the control chip; wherein the negative terminal of the first LED string is coupled to the control chip; wherein the negative terminal of the second LED string is coupled to the control chip; wherein the negative terminal of the third LED string is coupled to the control chip; wherein the negative terminal of the fourth LED string is coupled to the control chip; and wherein the negative terminal of the fifth LED string is coupled to the control chip.

7. The lighting apparatus of claim 5, wherein the control chip comprises: a DUT1 pin, a VIN pin, a DATA pin, a CLK pin, a DUT2 pin, a DUT3 pin, a DUT4 pin, and a DUT5 pin; wherein the DUT1 pin is coupled to the negative terminal of the first LED string; wherein the VIN pin is coupled to the second terminal of the resistor; wherein the DATA pin is coupled to the first terminal of the first capacitor; wherein the CLK pin is coupled to the first terminal of the second capacitor; wherein the DUT2 pin is coupled to the negative terminal of the second LED string; wherein the DUT3 pin is coupled to the negative terminal of the third LED string; wherein the DUT4 pin is coupled to the negative terminal of the fourth LED string; and wherein the DUT5 pin is coupled to the negative terminal of the fifth LED string.

8. The lighting apparatus of claim 1, wherein the LED controller circuit is configured to: detect a voltage ripple pattern of the DC power during a plurality of dimming cycles; determine a dimming curve based on the voltage ripple pattern; and adjust brightness levels of the plurality of LED modules of different types according to different scaling factors derived from the dimming curve, wherein each type of the plurality of LED modules has a unique scaling factor to maintain a desired color mixing ratio across different dimming levels.

9. The lighting apparatus of claim 1, wherein the bleeder circuit comprises: a dynamic impedance adjustment circuit configured to modulate an impedance value of the bleeder circuit based on a detected phase angle of the dimmer; and a thermal protection circuit configured to temporarily disable the bleeder circuit when a temperature of the bleeder circuit exceeds a threshold value, wherein the thermal protection circuit is further configured to re-enable the bleeder circuit in a pulse width modulated manner to maintain dimmer compatibility while reducing heat generation.

10. The lighting apparatus of claim 1, further comprising a dimming pattern learning circuit configured to store a plurality of historical dimming patterns; wherein the dimming pattern learning circuit is configured to identify a type of the dimmer based on comparing a current dimming pattern with the plurality of historical dimming patterns; and wherein the LED controller circuit is configured to adjust operation parameters of the bleeder circuit based on the identified type of the dimmer to optimize power efficiency while maintaining dimmer compatibility.

11. The lighting apparatus of claim 1, wherein the LED controller circuit comprises a protection circuit for stabilizing input current.

12. The lighting apparatus of claim 1, further comprising a dimmer health monitoring circuit configured to: detect abnormal behavior patterns of the dimmer; predict potential dimmer failure based on the detected abnormal behavior patterns; and adjust operating parameters of the bleeder circuit to extend operational lifetime of the dimmer while maintaining normal operation of the lighting apparatus.

13. The lighting apparatus of claim 1, wherein the LED controller is further configured to dynamically adjust the plurality of driving currents based on a detected color temperature setting, enabling the light source to produce a tunable white light by combining the outputs of the plurality of LED modules.

14. The lighting apparatus of claim 1, wherein the dimmer detector circuit further includes a signal analysis module capable of distinguishing between leading-edge and trailing-edge dimmers, and wherein the LED controller adjusts the plurality of driving currents based on the dimmer type detected to ensure compatibility and optimal performance.

15. The lighting apparatus of claim 1, wherein the bleeder circuit further comprises an adaptive feedback mechanism configured to minimize power loss by adjusting its operation based on the real-time impedance of the dimmer coupled to the lighting apparatus.

16. The lighting apparatus of claim 1, wherein the LED controller is configured to independently modulate the intensity of each LED module based on ambient light detected by an integrated light sensor, providing automatic brightness adjustment for energy efficiency.

17. The lighting apparatus of claim 1, wherein the LED controller includes a flicker mitigation module that adjusts the driving currents to maintain a constant and flicker-free light output, even under varying input power conditions caused by the dimmer.

18. The lighting apparatus of claim 1, wherein the LED controller further comprises an emergency mode circuit that detects power interruptions and switches the lighting apparatus to a low-power mode using stored energy in a backup capacitor to illuminate a subset of the LED modules.

19. The lighting apparatus of claim 1, further comprising a manual switch operably connected to the dimmer detector circuit, wherein the manual switch allows a user to manually indicate whether a dimmer is connected, and the LED controller adjusts the plurality of driving currents accordingly to optimize compatibility and performance.

20. The lighting apparatus of claim 1, further comprising a manual switch for user input to override the dimmer detector circuit, wherein the manual switch enables a predefined non-dimmer mode to bypass dimmer-related adjustments by the LED controller, ensuring stable operation in scenarios where a dimmer is not used.
